(19) United States
(12) Patent Application Publication
(10) Pub. No.: US 2025/0379543 A1
(43) Pub. Date: Dec. 11, 2025

(54) PRE-ASSEMBLED PHOTOVOLTAIC SYSTEMS

(71) Applicant: XI'AN LONGI CLEAN ENERGY CO., LTD., Xi'an (CN)

(72) Inventors: Kang ZHOU, Xi'an (CN); Jiangtao HE, Xi'an (CN); Na ZHANG, Xi'an (CN); Hua HUANG, Xi'an (CN); Jinghang WANG, Xi'an (CN); Mengnan WANG, Xi'an (CN); Xiliang LIU, Xi'an (CN); Lei ZHANG, Xi'an (CN)

(21) Appl. No.: 19/221,345

(22) Filed: May 28, 2025

(30) Foreign Application Priority Data
Jun. 6, 2024 (CN) 202421294100.5
Jul. 9, 2024 (CN) 202410919539.0

(51) Int. Cl. H02S 30/20; H02S 10/40; H02S 20/30; H02S 30/10

(52) U.S. Cl. CPC H02S 30/20; H02S 10/40; H02S 20/30; H02S 30/10

(57) ABSTRACT

Devices, apparatus, and systems for pre-assembled photovoltaic systems are provided. In one example, a pre-assembled photovoltaic system includes: a foldable support, a photovoltaic module fixed to the foldable support, and a limiting device connected to the foldable support. The limiting device is configured to control one or more unfolding angles of the foldable support.

### CROSS-REFERENCE TO RELATED APPLICATIONS

The present application claims priorities to Chinese Patent Application No. 202421294100.5 filed on Jun. 6, 2024 and Chinese Patent Application No. 202410919539.0 filed on Jul. 9, 2024. The disclosures of the aforementioned applications are herein incorporated by reference in their entireties.

### TECHNICAL FIELD

The present disclosure relates to the field of photovoltaic technologies, and in particular, to photovoltaic systems.

### BACKGROUND

In a conventional photovoltaic power station, a single photovoltaic matrix includes a pile foundation, a support, and a photovoltaic module. A sequence of on-site construction of the pile foundation, the support, and the photovoltaic module is that the pile foundation is first constructed, the support is mounted on an accepted pile foundation, the pile foundation and the support are constructed to form a module support system, and then the photovoltaic module is mounted on the support, thereby forming a photovoltaic power generation unit. The foregoing construction sequence is non-adjustable, the overall construction process is extremely complex, the construction time of the photovoltaic power generation unit is long, labor costs are high, and the overall mounting efficiency is relatively low.

### SUMMARY

The present disclosure provides a pre-assembled photovoltaic system, which can solve a problem of low mounting efficiency of an existing photovoltaic system.

Implementation of the present disclosure provides a pre-assembled photovoltaic system. The pre-assembled photovoltaic system includes: a foldable support; at least a pair of photovoltaic modules which are connected to the foldable support; and a limiting device connected to the foldable support, where the limiting device is configured to control unfolding angles of the foldable support.

In this embodiment of the present disclosure, the photovoltaic module may be mounted on the foldable support before the pre-assembled photovoltaic system leaves a factory. Then, the overall pre-assembled photovoltaic system is folded by folding the foldable support, so that an overall volume of the pre-assembled photovoltaic system is relatively small, thereby facilitating transportation of the pre-assembled photovoltaic system. After the pre-assembled photovoltaic system is transported to amounting site, the pre-assembled photovoltaic system can be unfolded only by mounting the foldable support to the mounting platform on the mounting site. The limiting device may be configured to control unfolding angles between foldable supports to improve structural stability of the pre-assembled photovoltaic system. In this way, the pre-assembled photovoltaic system according to this embodiment of the present disclosure facilitates transporting, can greatly shorten on-site construction time, simplify manual operation procedures, and greatly improve on-site mounting efficiency.

In some embodiments, the foldable support further includes at least a pair of limit plates arranged on the foldable support along an unfolding direction of the foldable support. In response to unfold the foldable support to a preset angle, the pair of limit plates abut against each other to prevent the foldable support from further unfolding, so that the foldable support can be maintained at the preset unfolding angle, thereby improving unfolding stability of the pre-assembled photovoltaic system.

In some embodiments, the foldable support includes at least a pair of cross beams arranged along an unfolding direction of the foldable support, a support unit hinged between the pair of cross beams, so as to switch between an unfolded state and a folded state.

In some embodiments, the foldable support includes a pair of stop plates disposed at a bottom of the pair of cross beams, in response to unfold the foldable support, the stop plate is configured to prevent the cross beam from flipping, where the foldable support is in a closed position, the pair of stop plates abut against each other. In a case that the foldable support is in the folded state, the stop plates on two adjacent cross beams abut against each other. Adjacent components are prevented from colliding with each other, and transportation safety of the pre-assembled photovoltaic system is improved. In addition, during unfolding of the pre-assembled photovoltaic system, the stop plates may further be configured to prevent the cross beams from rolling on the mounting platform, thereby improving assembly efficiency of the pre-assembled photovoltaic system.

In some embodiments, the stop plate includes: a bottom plate connected to the bottom of the cross beam and extending in a first direction; and two warping plates disposed at two ends of the bottom plate and extending in a second direction, where an included angle between the first direction and the second direction ranges from 0° to 90°. When the foldable support is in the unfolded state, the bottom plate may enlarge contact area between the cross beam and the mounting platform or a clump weight. In this way, the cross beam can be prevented from flipping. When the foldable support is in the folded state, the warping plates on the stop plates at the bottoms of two adjacent cross beams may abut against each other. Adjacent components are prevented from colliding with each other, and transportation safety of the pre-assembled photovoltaic system is improved.

In some embodiments, an anti-tip plate extending outward is disposed on a second hinge, and when the support is in the folded state, the anti-tip plate is located among a first support element, a second support element, and the cross beam. Once the pre-assembled photovoltaic system has tendency to roll, the anti-tip plate may abut against the cross beam, to prevent the pre-assembled photovoltaic system from rolling continuously, thereby preventing rolling and improving transportation safety of the pre-assembled photovoltaic system.

In some embodiments, at least one of a third part and a fourth part of the second hinge is provided with a limit part, and when the foldable support is folded, the third part and the fourth part abut against each other through the limit part to prevent the pre-assembled photovoltaic system from tipping over.

In some embodiments, the longitudinal beam of the first support is a first longitudinal beam, the longitudinal beam of the second support element is a second longitudinal beam, at least one of the first longitudinal beam and the second longitudinal beam has an open end, the open end faces a side facing away from the photovoltaic module, and a width of the longitudinal beam having the open end is greater than a width of the other longitudinal beam. In this way, in the folded state, the longitudinal beam having the open end and a relatively large width can accommodate the other longitudinal beam, so as to reduce a folded volume.

In some embodiments, the first longitudinal beam is misaligned with the second longitudinal beam in the first direction, so as to avoid interference between the first longitudinal beam and the second longitudinal beam in the folded state, and reduce a volume of the support after being folded.

The additional aspects and advantages of the present disclosure will be partially set forth in the following description, and some will become apparent from the following description, or will be understood by the practice of the present disclosure.

### BRIEF DESCRIPTION OF THE DRAWINGS

The above and/or additional aspects and advantages of the present disclosure will become apparent and readily understood from the description of embodiments in combination with accompanying drawings.

FIG. 1 is a first schematic structural diagram of a pre-assembled photovoltaic system according to an embodiment of the present disclosure in an unfolded state.

FIG. 2 is a second schematic structural diagram of a pre-assembled photovoltaic system according to an embodiment of the present disclosure in an unfolded state.

FIG. 3 is an enlarged schematic structural diagram of a position A of the pre-assembled photovoltaic system shown in FIG. 1.

FIG. 4 is an enlarged schematic structural diagram of a position B of the pre-assembled photovoltaic system shown in FIG. 1.

FIG. 5 is a schematic structural diagram of a support unit of the pre-assembled photovoltaic system shown in FIG. 1.

FIG. 6 is a schematic structural diagram of a first support in the support unit shown in FIG. 5.

FIG. 7 is a schematic structural diagram of the first support on which a photovoltaic module is mounted shown in FIG. 6.

FIG. 8 is a first schematic structural diagram of a pre-assembled photovoltaic system according to an embodiment of the present disclosure in a folded state.

FIG. 9 is a second schematic structural diagram of a pre-assembled photovoltaic system according to an embodiment of the present disclosure in a folded state.

FIG. 10 is an enlarged schematic structural diagram of a position C of the pre-assembled photovoltaic system shown in FIG. 9.

FIG. 11 is a third schematic structural diagram of a pre-assembled photovoltaic system according to an embodiment of the present disclosure in a folded state.

FIG. 12 is a schematic structural diagram of a cross beam according to an embodiment of the present disclosure.

FIG. 13 is a schematic structural diagram of a first hinge according to an embodiment of the present disclosure in an unfolded state.

FIG. 14 is a schematic structural diagram of a first hinge according to an embodiment of the present disclosure in a folded state.

FIG. 15 is a first schematic structural diagram of a first longitudinal beam and a second longitudinal beam according to an embodiment of the present disclosure in a folded state.

FIG. 16 is a second schematic structural diagram of a first longitudinal beam and a second longitudinal beam according to an embodiment of the present disclosure in a folded state.

FIG. 17 is a first schematic diagram of connecting a cross beam to a clump weight according to an embodiment of the present disclosure.

FIG. 18 is a second schematic diagram of connecting a cross beam to a clump weight according to an embodiment of the present disclosure.

FIG. 19 is a third schematic diagram of connecting a cross beam to a clump weight according to an embodiment of the present disclosure.

FIG. 20 is a schematic structural diagram of another pre-assembled photovoltaic system according to an embodiment of the present disclosure.

FIG. 21 is an enlarged schematic structural diagram of a position D of a pre-assembled photovoltaic system shown in FIG. 20.

FIG. 22 is a schematic structural diagram of a second hinge in a pre-assembled photovoltaic system shown in FIG. 20.

FIG. 23 is a schematic structural diagram of a second hinge in a pre-assembled photovoltaic system shown in FIG. 10.

FIG. 24 is a schematic diagram of a layout of a pre-assembled photovoltaic system in a container according to an embodiment of the present disclosure.

FIG. 25 is an enlarged schematic structural diagram of a position E of the pre-assembled photovoltaic system shown in FIG. 9.

Reference signs in the drawings: 100—pre-assembled photovoltaic system, 1—support, 10—cross beam, 101—stop plate, 1011—bottom plate, 1012—warping plate, 11—first support element, 111—first longitudinal beam, 112—first transverse purlin, 12—second support element, 121—second longitudinal beam, 13—first hinge, 131—first part, 132—second part, 133—first rotating shaft, 134—limit plate, 14—second hinge, 141—third part, 142—fourth part, 143—second rotating shaft, 144—anti-tip plate, 145—limit part, 2—photovoltaic module, 3—limiting device, 4—clump weight, 40—pre-buried piece, 41—fastener, 42—hoop, 43—limit slot, and 5—pallet, 110—support unit.

### DETAILED DESCRIPTION

Embodiments of the present disclosure are described below in detail, and examples of the embodiments are shown in accompanying drawings, where the same or similar reference numerals represent the same or similar elements or the elements having same or similar functions throughout the description. The embodiments described below with reference to the drawings are exemplary, which are only intended to explain the present disclosure and cannot be construed as a limitation on the present disclosure. All other embodiments obtained by a person of ordinary skill in the art based on the embodiments of the present disclosure without making creative efforts shall fall within the protection scope of the present disclosure.

Features limited by terms “first” and “second” in the specification and claims of the present disclosure may explicitly or implicitly include one or more of the features. In the description of the present disclosure, unless otherwise specified, “a plurality of” means two or more than two. In addition, “and/or” in the specification and the claims generally indicates at least one of connected objects, and the character “/” generally indicates an “or” relationship between associated objects.

In the description of the present disclosure, it is to be understood that orientation or position relationships indicated by the terms such as “center”, “longitudinal”, “transverse”, “length”, “width”, “thickness”, “on”, “below”, “front”, “back”, “left”, “right”, “vertical”, “horizontal”, “top”, “bottom”, “inside”, “outside”, “clockwise”, “anticlockwise”, “axial”, “radial”, and “circumferential” are based on orientation or position relationships shown in the accompanying drawings, and are used only for describing the present disclosure and simplifying the description, rather than indicating or implying that the mentioned apparatus or element needs to have a particular orientation or needs to be constructed and operated in a particular orientation. Therefore, such terms are not to be construed as limiting of the present disclosure.

In the descriptions of the present disclosure, it is to be noted that, unless otherwise explicitly specified or defined, the terms such as “mount”, “interconnect”, and “connect” are to be understood in a broad sense. For example, the connection may be a fixed connection, a detachable connection, or an integral connection; or the connection may be a mechanical connection or an electrical connection; or the connection may be a direct connection, an indirect connection through an intermediate medium, or internal communication between two elements. For those of ordinary skill in the art, specific meanings of the terms described above in the present disclosure may be understood according to specific conditions.

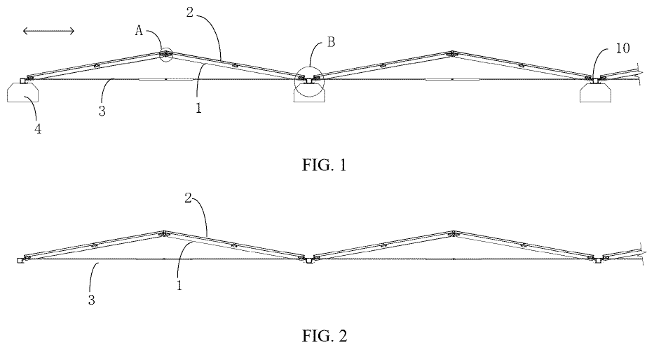

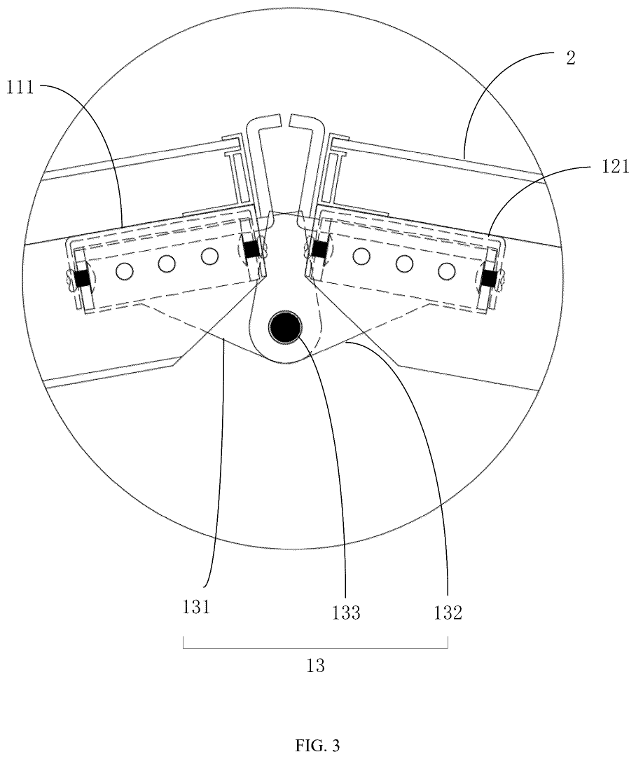

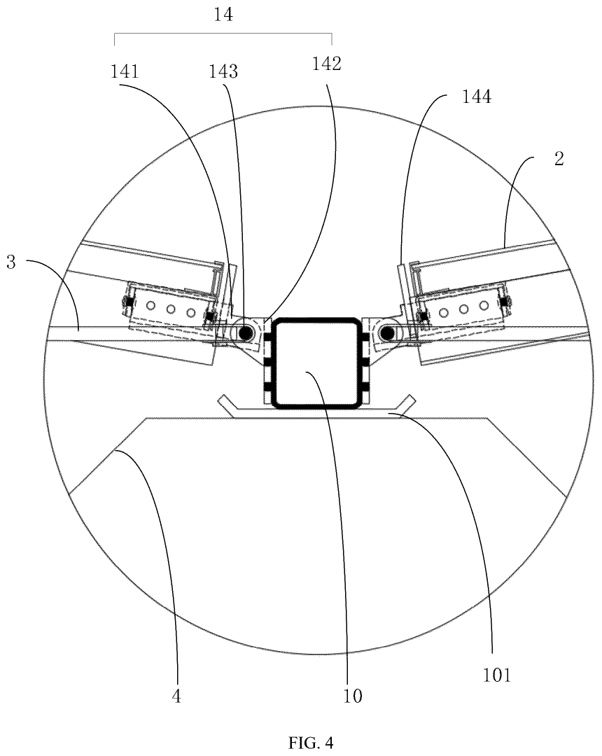

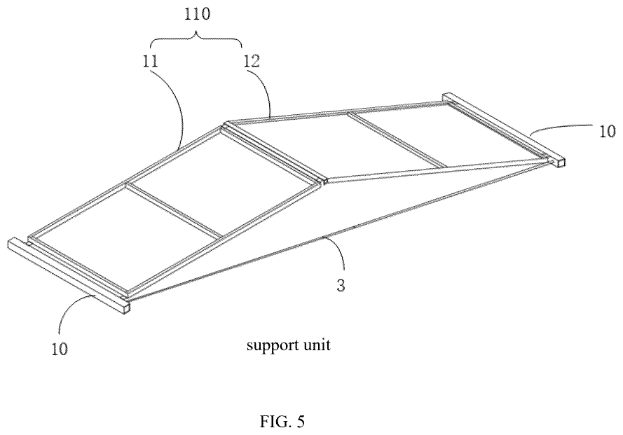

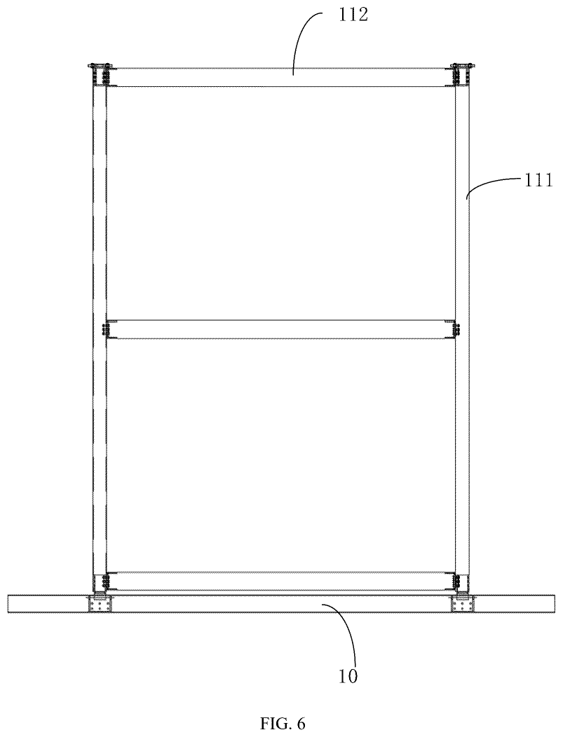

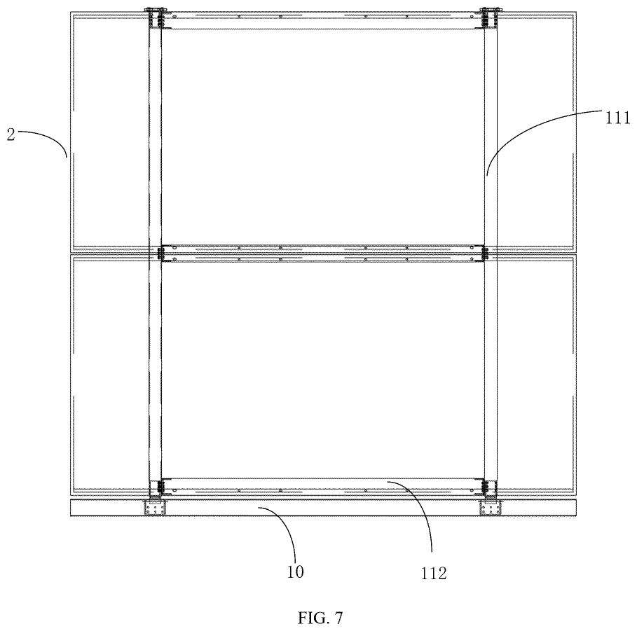

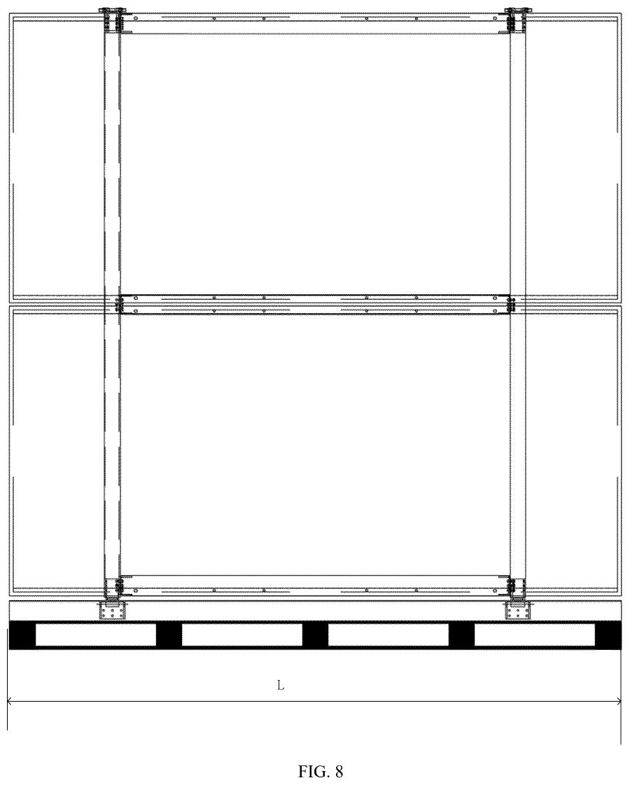

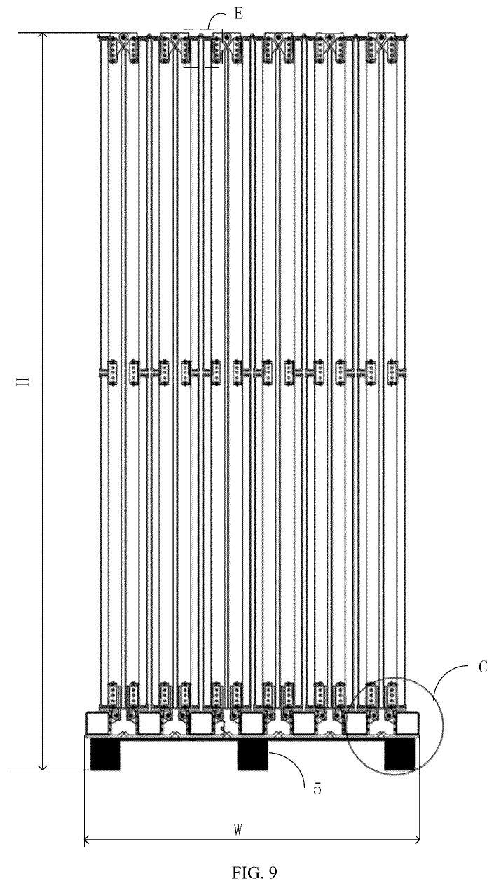

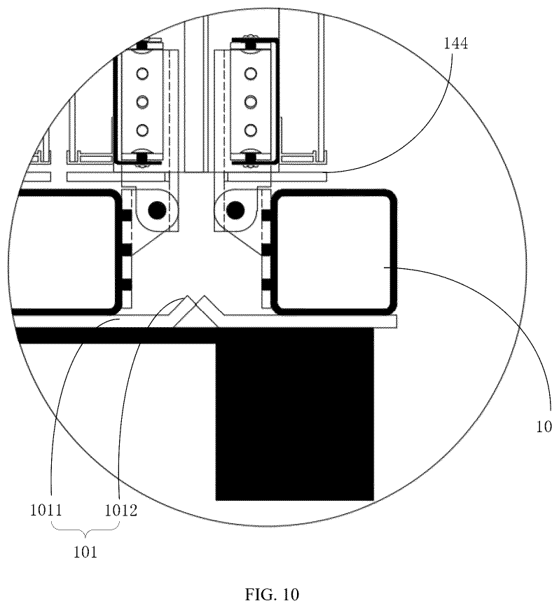

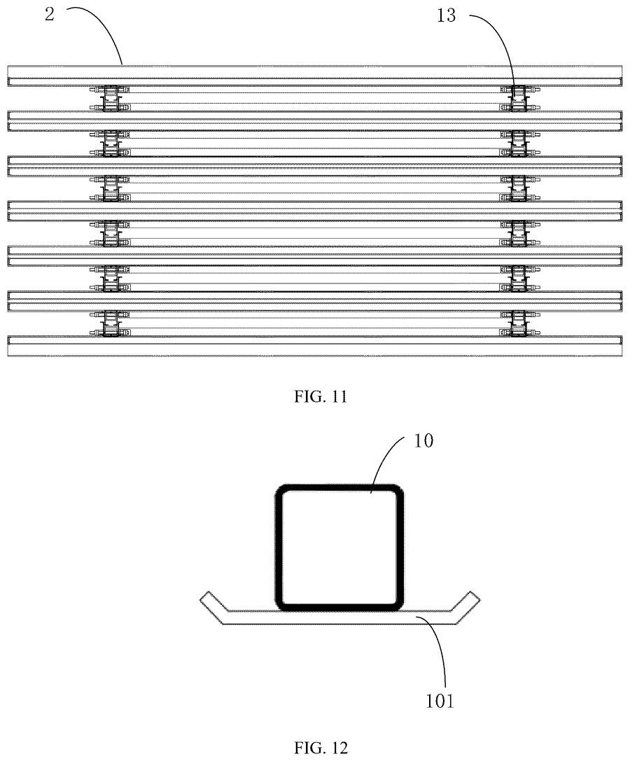

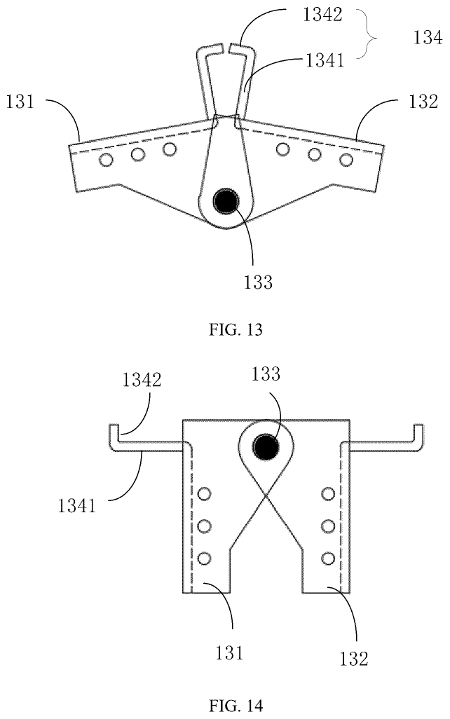

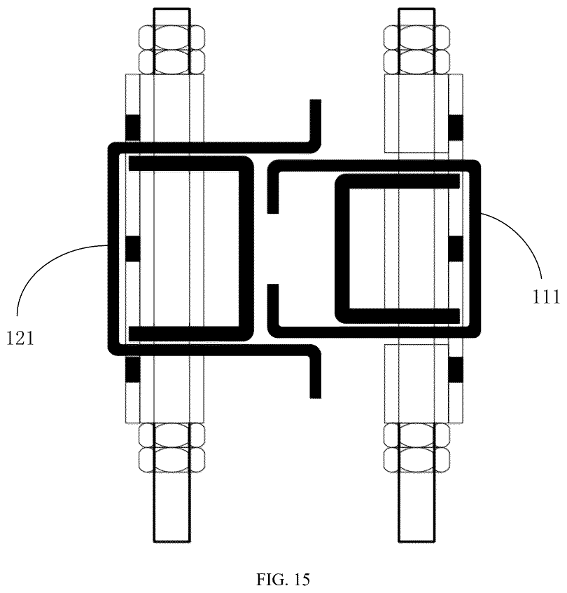

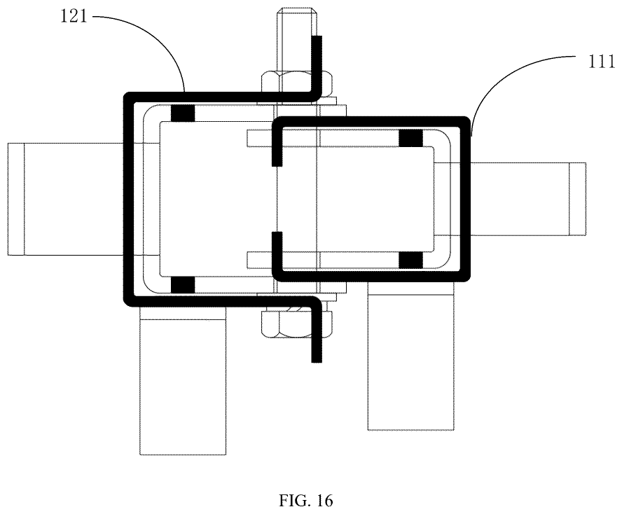

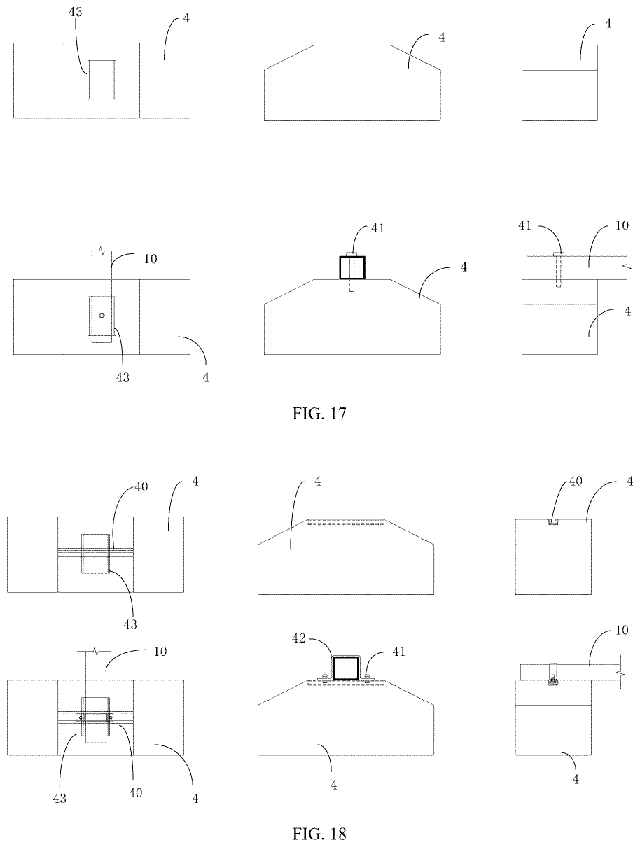

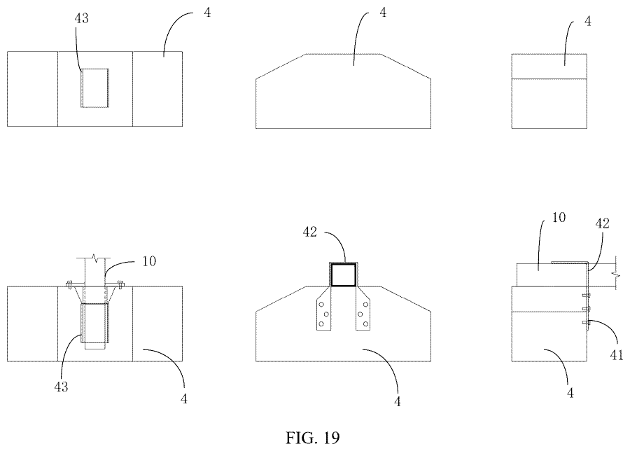

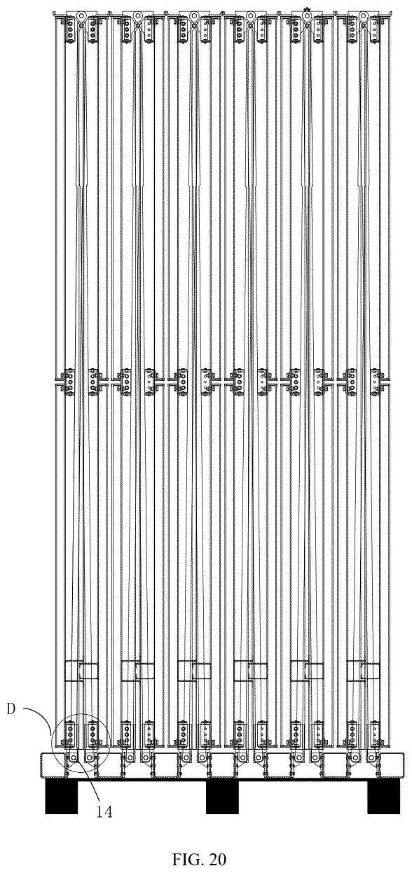

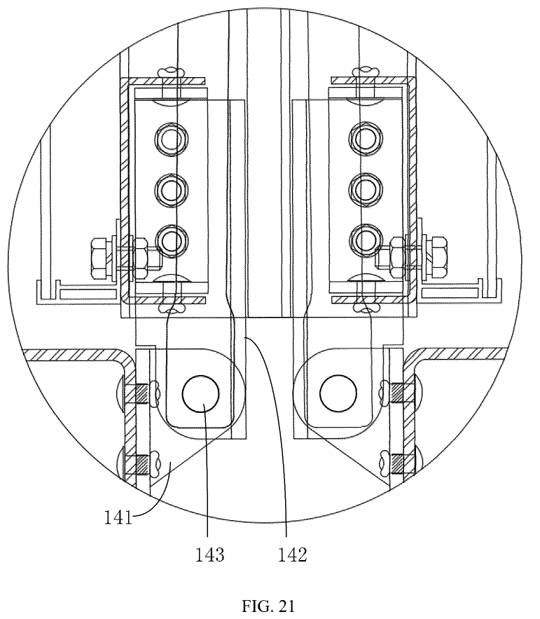

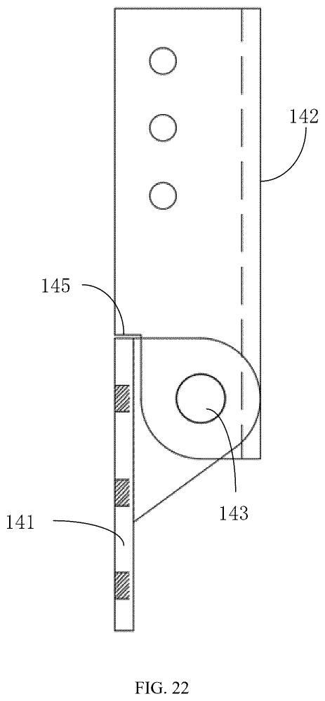

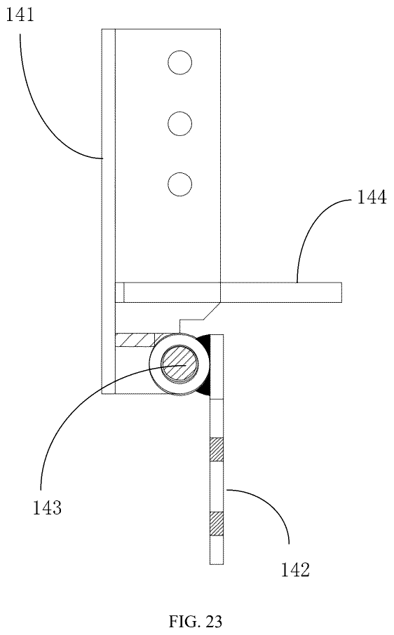

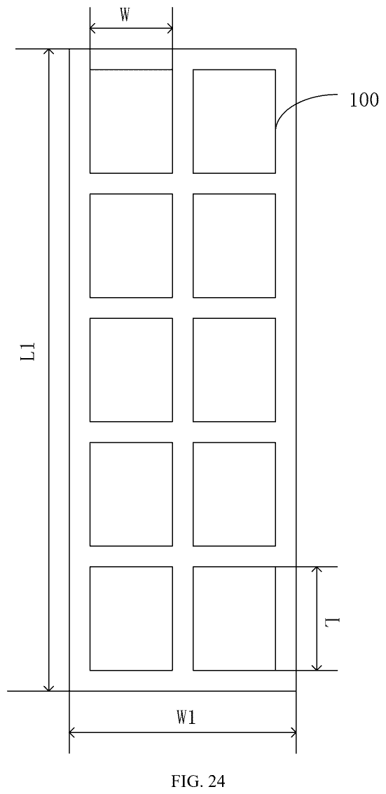

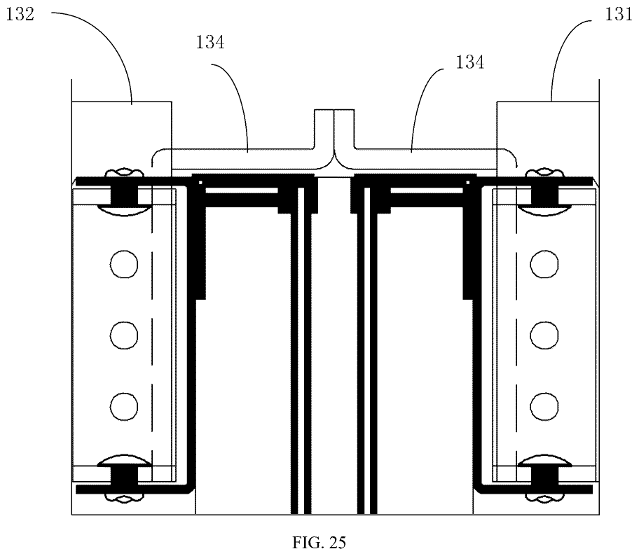

A photovoltaic system can be a pre-assembled photovoltaic system that can include a portable photovoltaic array. Refer to FIG. 1, which is a first schematic structural diagram of a pre-assembled photovoltaic system according to an embodiment of the present disclosure in an unfolded state. Refer to FIG. 2, which is a second schematic structural diagram of a pre-assembled photovoltaic system according to an embodiment of the present disclosure in an unfolded state. Refer to FIG. 3, which is an enlarged schematic structural diagram of a position A of the pre-assembled photovoltaic system shown in FIG. 1. Refer to FIG. 4, which is an enlarged schematic structural diagram of a position B of the pre-assembled photovoltaic system shown in FIG. 1. Refer to FIG. 5, which is a schematic structural diagram of a support unit of the pre-assembled photovoltaic system shown in FIG. 1. Refer to FIG. 6, which is a schematic structural diagram of a first support in the support unit shown in FIG. 5. Refer to FIG. 7, which is a schematic structural diagram of the first support on which a schematic module is mounted shown in FIG. 6. Refer to FIG. 8, which is a first schematic structural diagram of a pre-assembled photovoltaic system according to an embodiment of the present disclosure in a folded state. Refer to FIG. 9, which is a second schematic structural diagram of a pre-assembled photovoltaic system according to an embodiment of the present disclosure in a folded state. Refer to FIG. 10, which is an enlarged schematic structural diagram of a position C of the pre-assembled photovoltaic system shown in FIG. 9. Refer to FIG. 11, which is a third schematic structural diagram of a pre-assembled photovoltaic system according to an embodiment of the present disclosure in a folded state. Refer to FIG. 12, which is a schematic structural diagram of a cross beam according to an embodiment of the present disclosure. Refer to FIG. 13, which is a schematic structural diagram of a first hinge according to an embodiment of the present disclosure in an unfolded state. Refer to FIG. 14, which is a schematic structural diagram of a first hinge according to an embodiment of the present disclosure in a folded state. Refer to FIG. 15, which is a first schematic structural diagram of a first longitudinal beam and a second longitudinal beam according to an embodiment of the present disclosure in a folded state. Refer to FIG. 16, which is a second schematic structural diagram of a first longitudinal beam and a second longitudinal beam according to an embodiment of the present disclosure in a folded state. Refer to FIG. 17, which is a first schematic diagram of connecting a cross beam to a clump weight according to an embodiment of the present disclosure. Refer to FIG. 18, which is a second schematic diagram of connecting a cross beam to a clump weight according to an embodiment of the present disclosure. Refer to FIG. 19, which is a third schematic diagram of connecting a cross beam to a clump weight according to an embodiment of the present disclosure. Refer to FIG. 20, which is a schematic structural diagram of another pre-assembled photovoltaic system according to an embodiment of the present disclosure. Refer to FIG. 21, which is an enlarged schematic structural diagram of a position D of a pre-assembled photovoltaic system shown in FIG. 20. Refer to FIG. 22, which is a schematic structural diagram of a second hinge in a pre-assembled photovoltaic system shown in FIG. 20. Refer to FIG. 23, which is a schematic structural diagram of a second hinge in a pre-assembled photovoltaic system shown in FIG. 10. Refer to FIG. 24, which is a schematic diagram of a layout of a pre-assembled photovoltaic system in a container according to an embodiment of the present disclosure. Refer to FIG. 25, which is an enlarged schematic structural diagram of a position E of the pre-assembled photovoltaic system shown in FIG. 9.

In some embodiments, the pre-assembled photovoltaic system may include: a foldable support 1; a photovoltaic module 2, where the photovoltaic module 2 is fixed to the foldable support 1; and a limiting device 3, where the limiting device 3 is connected to the foldable support 1, and the limiting device 3 may be configured to control unfolding angles of the foldable support 1.

In some embodiments, a photovoltaic module 2 includes: a plurality of solar cells, ribbons, busbar, adhesive film, cover plate, back plate and frame. Solar cells convert sunlight into electricity and connected in series or parallel by the ribbons. Busbars are thin strips of conductive material and are used to collect the electric current generated by the solar cells and carry it out of the module. Adhesive film is a layer of adhesive material that bonds the different components of the photovoltaic module together, providing structural integrity and protection against environmental factors. The cover plate is a transparent or translucent sheet of glass or plastic that protects the solar cells from dust, dirt, moisture, and other external elements. The back plate is a protective layer at the back of the module, providing structural support and additional protection for the internal components. The frame is a rigid structure that holds all the components of the module together and provides mechanical support for the module when installed.

In this embodiment of the present disclosure, the photovoltaic module 2 may be mounted on the foldable support 1 before the pre-assembled photovoltaic system leaves a factory. Then, the overall pre-assembled photovoltaic system is folded by folding the foldable support 1, so that an overall volume of the pre-assembled photovoltaic system is relatively small, thereby facilitating transportation of the pre-assembled photovoltaic system. After the pre-assembled photovoltaic system is transported to a mounting site, the pre-assembled photovoltaic system can be unfolded only by mounting the foldable support I to a clump weight 4 or the ground on the mounting site. Under a tightening force of the limiting device 3, the pre-assembled photovoltaic system can be reliably maintained at a required unfolding angle, thereby improving structural stability of the pre-assembled photovoltaic system. In this way, the pre-assembled photovoltaic system according to this embodiment of the present disclosure facilitates transporting, can greatly shorten on-site construction time, simplify manual operation procedures, and greatly improve on-site mounting efficiency.

In a specific application, during transportation of the pre-assembled photovoltaic system, the limiting device 3 may be stored together with the foldable support 1 in a folded state, or may be stored independently. This is not limited in this embodiment of the present disclosure.

In some embodiments, after the pre-assembled photovoltaic system is mounted on the mounting site, the folded foldable supports I may be unfolded in sequence. In an unfolding process, the limiting device 3 mounted on the foldable support 1 is slowly unfolded as unfolding of the foldable support 1. When the foldable support 1 is unfolded to a preset angle, the limiting device 3 is completely unfolded, and a tightening force in an opposite direction is applied to the foldable support 1 that continues to be unfolded, to prevent the foldable support 1 from continuing to be unfolded, so that the foldable support I can be maintained at the preset angle, thereby avoiding further sinking of the foldable support 1 under the gravity of the photovoltaic module 2.

As shown in FIG. 1, the foldable support 1 specifically includes a plurality of cross beams 10 spaced away from each other in a first direction (a direction shown by an arrow in FIG. 1), and a support unit (110) shown in FIG. 5 is disposed between two adjacent cross beams 10. As shown in FIG. 5, the support unit (110) is hinged to each of the two adjacent cross beams 10, so as to switch the foldable support 1 between an unfolded state (or an open position) and a folded state (or a closed position).

In an actual application, the photovoltaic module 2 may be fixedly mounted on the support unit first. Then, the plurality of cross beams 10 spaced away from each other in the first direction are folded to implement folding of the photovoltaic array. After reaching the mounting site, the foldable support I can be unfolded by increasing a distance between the cross beams 10.

In some embodiments, a quantity of the support units may be set according to an actual requirement. For example, there may be 1, 2, 3, 4, 5, 6, or the like support units. The quantity of the support units is not specifically limited in this embodiment of the present disclosure.

As shown in FIG. 5, the support unit (110) includes a first support element 11 and a second support element 12 that are disposed in the first direction. Both the first support element 11 and the second support element 12 include a first end and a second end. The first end of the first support element 11 is hinged to the first end of the second support element 12. The second end of the first support element 11 and the second end of the second support element 12 are respectively hinged to two adjacent cross beams 10. Each of the first support element 11 and the second support element 12 is connected to at least one photovoltaic module 2. Through hinge between the first end of the first support element 11 and the first end of the second support element 12, and hinge among the second end of the first support element 11, the second end of the second support element 12 and the cross beam 10, so as to switch the overall foldable support 1 between the folded state and the unfolded state.

In an actual application, there are a plurality of photovoltaic modules 2. Each of the first support element 11 and the second support element 12 is connected to at least one photovoltaic module 2. The accompanying drawings in this embodiment of the present disclosure only show a schematic structural diagram in which two photovoltaic modules 2 are mounted on each of the first support element 11 and the second support element 12. In an actual application, those skilled in the art may set quantities of the photovoltaic modules 2 on the first support element 11 and the second support element 12 according to an actual requirement. For example, there may be 1, 3, 5, or the like photovoltaic modules 2 on the first support element 11 and the second support element 12. This is not limited in this embodiment of the present disclosure.

As shown in FIG. 3, the support unit (110) may further include a first hinge 13. The first hinge 13 is connected between the first end of the first support element 11 and the first end of the second support element 12, to implement hinge between the first support element 11 and the second support element 12. The support unit (110) may further include a second hinge 14. The second hinge 14 is connected among the second end of the first support element 11, the second end of the second support element 12, and the cross beam 10, to implement hinge among the first support element 11, the second support element 12, and the cross beam 10.

In some embodiments, at the mounting site, the first direction may be an east-west direction. After the foldable support 1 is unfolded, to enable the power generation capacity of the photovoltaic module 2 to be relatively high, an angle needs to be maintained between the photovoltaic module 2 and a horizontal plane of the mounting site. Correspondingly, an appropriate angle also needs to be maintained between the first support element 11 and the second support element 12.

For example, after the foldable support 1 is unfolded to a target angle, an included angle between the photovoltaic module 2 on the foldable support 1 and a mounting surface of the mounting site may be any one of 5° to 30°. For example, the foregoing included angle may be 5°, 10°, 20°, 30°, or the like. Correspondingly, in the same support unit (110) in the foldable support 1, an included angle between the first support element 11 and the second support element 12 may be any one of 120° to 170°, for example, 120°, 140°, 160°, 170°, or the like.

It is to be noted that, in a specific application, the foregoing angles may be properly selected according to a geographical position (for example, latitude and longitude) of a mounting site, a climatic environment (for example, an anti-wind load), and power generation efficiency of the photovoltaic module 2.

In an embodiment of the present disclosure, the limiting device 3 may be disposed between the first support element 11 and the second support element 12 in the support unit (110). The limiting device 3 is connected to each of the first support element 11 and the second support element 12. After the foldable support 1 is unfolded, an included angle among the first support element 11, the second support element 12, and the limiting device 3 may be 5° to 30°, so that power generation capacity of the photovoltaic modules 2 on the first support element 11 and the second support element 12 is relatively high.

For example, the included angle among the first support element 11, the second support element 12, and the limiting device 3 may be 5°, 10°, 18°, 25°, 30°, or the like. This is not specifically limited in this embodiment of the present disclosure.

In some embodiments, the limiting device 3 may be at any one of a steel wire rope, a rigid pull rod, a telescopic rod, and a foldable rod. The limiting device 3 is not specifically limited in this embodiment of the present disclosure.

In some embodiments, the limiting device 3 may be connected to the first support element 11 and the second support element 12, for example, connected to a first longitudinal beam 111 of the first support element 11 and a second longitudinal beam 121 of the second support element 12. Or, the limiting device 3 may further be connected to the second hinge 14 through which the first support element 11 and the second support element 12 are connected to the cross beam 10, to move together with the second hinge 14, to limit in the unfolded state. Or, the limiting device 3 may further be connected to transverse purlins of the first support element 11 and the second support element 12.

In some embodiments of the present disclosure, the limiting device 3 may be connected to the longitudinal beam, a connection position between the limiting device 3 and the longitudinal beam is a target position, a distance between the target position and the cross beam is a target distance, and a ratio between the target distance and a total length of the longitudinal beam is: 0-⅔, so as to further improve a tightening effect of the limiting device for the foldable support 1, thereby better maintaining the foldable support 1 at a required unfolding angle.

For example, in a case that the limiting device 3 is a rigid rod, the rigid rod may include two parts that are rotatably connected. One part is connected to the second hinge 14 through which the first support element 11 is connected to the cross beam 10, and the other part is connected to the second hinge 14 through which the second support element 12 is connected to the cross beam 10.

In some embodiments of the present disclosure, at least a pair of limit plates 134 disposed in the first direction is further disposed on the foldable support. When the foldable support 1 is unfolded to a preset angle, adjacent limit plates 134 abut against each other, to prevent the foldable support 1 from further unfolding, so that the foldable support I can be maintained at a required unfolding angle, thereby improving unfolding stability of the pre-assembled photovoltaic system.

As shown in FIG. 3, the first hinge 13 may be a hinge. The hinge may include: a first rotating shaft 133; and a first part 131 and a second part 132 that are sleeved over the first rotating shaft 133. The first part 131 is connected to the first end of the first support element 11 through a fastener, for example, a bolt or a screw, and the second part 132 is connected to the first end of the second support element 12 through a fastener, for example, a bolt or a screw.

As shown in FIG. 13 and FIG. 14, a pair of limit plates 134 is disposed on the first part and the second part respectively. As shown in FIG. 14 and FIG. 25, when the foldable support 1 is folded, adjacent limit plates 134 of adjacent support units abut against each other. As shown in FIG. 13 and FIG. 3, when the foldable support 1 is unfolded, the limit plate 134 on the first part 131 and the limit plate 134 on the second part 132 abut against each other, to prevent the foldable support 1 from further unfolding.

In the folded state shown in FIG. 15, adjacent limit plates 134 of adjacent support units abut against each other, to prevent the photovoltaic modules 2 on two support units from colliding with each other, thereby improving transportation safety of the pre-assembled photovoltaic system. In an unfolded state shown in FIG. 13, in the same first hinge 13, the limit plate 134 on the first part 131 and the limit plate 134 on the second part 132 have a tendency to abut against each other, to prevent the foldable support from further unfolding, and avoid poor mounting caused by continued pressing down of the first support element 11 and the second support element 12 under the gravity of the photovoltaic modules 2. Particularly, when the lower limiting device 3 fails, the upper limit plate 134 can continue to ensure that the foldable support is at a preset unfolding angle.

As shown in FIG. 13 and FIG. 14, the limit plate 134 may specifically include an extension plate 1341 and a bent plate 1342. An end of the extension plate 1341 is connected to the first part 131 or the second part 132, and the bent plate 1342 is disposed at an other end of the extension plate 1341. In a hinge, the bent plates 1342 on the first part 131 and on the second part 132 are disposed opposite to each other. In this way, when the foldable support 1 is folded, the bent plates 1342 on the adjacent limit plates 134 of the adjacent support units may abut against each other. When the foldable support 1 is unfolded, in a hinge, the bent plate 1342 on the first part 131 and the bent plate 1342 on the second part may abut against each other, to prevent the foldable support 1 from further unfolding.

As shown in FIG. 10, a stop plate 101 may further be disposed at a bottom of the cross beam 10. When the foldable support 1 is unfolded, the stop plate 101 may further be configured to prevent the cross beam 10 from flipping, thereby preventing the cross beam 10 from rolling on a mounting platform or on a clump weight, and improving assembly efficiency of the pre-assembled photovoltaic system. When the foldable support 1 is in a folded state, stop plates 101 of two adjacent cross beams 10 may abut against each other, to prevent adjacent components from colliding with each other, thereby improving transportation safety of the pre-assembled photovoltaic system.

As shown in FIG. 10, the stop plate 101 may include a bottom plate 1011 extending in the first direction and warping plates 1012 disposed at two ends of the bottom plate 1011. The bottom plate 1011 is connected to the bottom of the cross beam 10, the warping plates 1012 extend in a direction away from the bottom plate, an extension direction of the warping plate 1012 has an included angle with a plane in which the bottom plate 1011 is located, and the included angle ranges from 0 to 90°.

In a specific application, a width of the bottom plate 1011 in the first direction may be greater than a width of the cross beam 10 in the first direction. Because the bottom plate 1011 is connected to the bottom of the cross beam 10, when the foldable support 1 is in an unfolded state, the bottom plate 1011 may increase contact area between the cross beam 10 and a mounting platform or a clump weight. In this way, the cross beam 10 can be prevented from flipping. When the foldable support 1 is in a folded state, the warping plates 1012 on the stop plates 101 at the bottoms of two adjacent cross beams 10 may abut against each other, to prevent adjacent components from colliding with each other, thereby improving transportation safety of the pre-assembled photovoltaic system.

As shown in FIG. 4, the second hinge 14 may alternatively be a hinge. The hinge may include: a second rotating shaft 143; and a third part 141 and a fourth part 142 that are sleeved over the second rotating shaft 143. The third part 141 is connected to the second end of the first support element 11 or the second end of the second support element 12 through a fastener, for example, a bolt or a screw. The fourth part 142 is connected to the cross beam 10 through a fastener, for example, a bolt or a screw.

As shown in FIG. 10 and FIG. 23, the third part 141 is provided with an anti-tip plate 144 extending outward. When the support 1 is in a folded state, the anti-tip plate 144 is located among the first support element 11, the second support element 12, and the cross beam 10. Once the pre-assembled photovoltaic system has a tendency to roll, the anti-tip plate 144 may abut against the cross beam 10, to prevent the pre-assembled photovoltaic system from rolling continuously, thereby preventing rolling and improving transportation safety of the pre-assembled photovoltaic system.

Or, as shown in FIG. 20 to FIG. 22, at least one of the third part 141 and the fourth part 142 of the second hinge 14 is provided with a limit part 145. When the foldable support 1 is folded, the third part 141 and the fourth part 142 abut against each other through the limit part 145 to prevent the pre-assembled photovoltaic system from tipping over.

In some embodiments, the limit part 145 may be, as shown in FIG. 22, a step type avoidance structure, a concave-convex fitting structure, or the like. A specific structure of the limit part 145 may not be limited in this embodiment of the present disclosure.

In some embodiments of the present disclosure, both the first support element 11 and the second support element 12 may include at least two longitudinal beams and at least two transverse purlins. The longitudinal beams and the transverse purlins are connected perpendicularly or crosswise to form a grid frame. The photovoltaic module 2 is fixed to the grid frame to achieve a stable connection of the photovoltaic modules 2 to the first support element 11 and the second support element 12.

As shown in FIG. 6, the longitudinal beams on the first support element 11 are first longitudinal beams 111, the transverse purlins on the first support element 11 are first transverse purlins 112, and the first transverse purlins 112 are connected to the first longitudinal beams 111 through fasteners.

Exemplarily, as shown in FIG. 7, there are two first longitudinal beams 111, and there are three first transverse purlins 112 between the two first longitudinal beams 111. The first transverse purlins 112 may be connected to the first longitudinal beams 111 through fasteners such as bolts or screws. The first support element 11 may be configured to mount two photovoltaic modules 2, and a frame of each photovoltaic module 2 may be connected to two first transverse purlins 112 disposed adjacently through a fastener.

Similarly, the longitudinal beams on the second support element 12 may be second longitudinal beams 121, the transverse purlins on the second support element 12 may be second transverse purlins, and the second transverse purlins are connected to the second longitudinal beams 121 through fasteners. For a specific structure of the second support element 12, refer to the first support element 11 shown in FIG. 6, and details are not described herein again.

It is to be noted that, in an actual application, in addition to the longitudinal beams and the transverse purlins, another support beam may further be disposed between the longitudinal beams and the transverse purlins on the first support element 11 and the second support element 12. The support beam may further be obliquely disposed relative to the longitudinal beams and the transverse purlins.

In some embodiments, the first longitudinal beam 111 on the first support element 11 and the second longitudinal beam 121 on the second support element 12 may be made of angle steel, a rectangular tube, a C-shaped tube, or the like. A material of the foregoing rectangular tube or the C-shaped tube may include, but is not limited to, a steel material, an aluminum alloy, a composite material, or the like. Specific structures of the first longitudinal beams 111 and the second longitudinal beams 121 may not be limited in this embodiment of the present disclosure.

In some embodiments of the present disclosure, to avoid interference between the first longitudinal beam 111 and the second longitudinal beam 121 in the folded state, and reduce a volume of the support 1 after being folded, the first longitudinal beam 111 may be misaligned with the second longitudinal beam 121 in the first direction.

In some other embodiments of the present disclosure, as shown in FIG. 15 and FIG. 16, in the first direction, the first longitudinal beam 111 is aligned with the second longitudinal beam 121. At least one of the first longitudinal beam 111 and the second longitudinal beam 121 has an open end. The open end faces a side facing away from the photovoltaic module 2, and a width of the longitudinal beam having the open end is greater than a width of the other longitudinal beam. In this way, in the folded state, the longitudinal beam having the open end and a relatively large width can accommodate the other longitudinal beam to reduce a volume after being folded.

For example, in a case that the first longitudinal beam 111 and the second longitudinal beam 121 are open C-type tubes, a width dimension of the first longitudinal beam 111 needs to be smaller than a width dimension of the second longitudinal beam 121, or a width dimension of the second longitudinal beam 121 needs to be smaller than a width dimension of the first longitudinal beam 111. In this way, in the folded state, the first longitudinal beam 111 may be entirely embedded into the second longitudinal beam 121, or the second longitudinal beam 121 may be entirely embedded into the first longitudinal beam 111 to reduce an overall volume of the folded foldable support 1.

In some embodiments, each of the first part 131 and the second part 132 of the first hinge 13 is provided with an extension plate. The extension plate may extend into the first longitudinal beam 111 or the second longitudinal beam 121, and is connected to the first longitudinal beam 111 or the second longitudinal beam 121 through a fastener.

In some embodiments of the present disclosure, the cross beam 10 may be directly connected to a mounting platform. The cross beam 10 may be directly mounted on the mounting platform through a fastener. Or, a pre-buried piece may be disposed in the mounting platform, and the cross beam 10 is connected to the pre-buried piece through a fastener. Alternatively, the pre-assembled photovoltaic system may further include a hoop. The hoop bypasses the cross beam 10 and is connected to the mounting platform through a fastener. A manner of connecting the cross beam 10 to the mounting platform is not specifically limited in this embodiment of the present disclosure.

In a specific application, the cross beam 10 is directly mounted on the mounting platform, so that not only a position of the cross beam 10 can be flexibly disposed, but also a structure of the overall pre-assembled photovoltaic system can be relatively simple.

As shown in FIG. 1, the pre-assembled photovoltaic system may further include: a plurality of clump weights 4. The plurality of clump weights are spaced away from each other in the first direction on a mounting plane. In a case that in the foldable support 1 is in the unfolded state, two ends of a cross beam 10 may be respectively mounted on one clump weight 4 through fasteners such as bolts and screws. In some embodiments, the clump weight 4 may be a cement foundation formed by casting cement, and the clump weight 4 may be configured to fixedly support the overall pre-assembled photovoltaic system.

As shown in FIG. 17, the cross beam 10 may be directly mounted on the clump weight 4 through a fastener 41. The fastener 41 shown in FIG. 17 may be specifically an expansion screw or the like.

As shown in FIG. 18, a pre-buried piece 40 is disposed in the clump weight. The cross beam 10 is connected to the pre-buried piece 40 through a fastener 41. In a case that the pre-buried piece 40 is provided, the fastener 41 may be a common bolt, screw, or the like.

In some embodiments, as shown in FIG. 18, the pre-assembled photovoltaic system may further include a hoop 42. The hoop may bypass the cross beam 10 and be connected to the pre-buried piece 40 through the fastener 41. Because contact area between the hoop 42 and the cross beam 10 is relatively large, the cross beam is connected to the clump weight 4 through the hoop 42, so that the reliability of connecting the cross beam 10 to the clump weight 4 can be further improved.

As shown in FIG. 18, the hoop 42 may be mounted from a top of the clump weight 4. As shown in FIG. 19, the hoop 42 may be mounted from a side surface of the clump weight 4. In an actual application, those skilled in the art may select a proper mounting manner according to a requirement. This is not specifically limited in this embodiment of the present disclosure.

In some embodiments, the clump weight 4 may be disposed below the cross beam 10. In the first direction, in the clump weights 4 located at two ends of the pre-assembled photovoltaic system (as shown in FIG. 17 to FIG. 19), a limit slot 43 configured to limit the cross beam 10 is disposed on the clump weight 4 at at least one end. In an actual application, the limit slot 43 may be disposed on only one of the clump weights 4 located at the two ends in the first direction, or the limit slots 43 may be disposed on both the clump weights 4 on the two ends, so as to limit the cross beam 10 in the first direction, thereby improving the mounting efficiency of the portable photovoltaic module at a mounting site.

In this embodiment of the present disclosure, to facilitate transportation of the pre-assembled photovoltaic system, a dimension of the pre-assembled photovoltaic system after being folded needs to be controlled, so that the dimension of the pre-assembled photovoltaic system after being folded can be adapted to a dimension of a container. For example, the pre-assembled photovoltaic system according to this embodiment of the present disclosure may be transported by using a 40-foot high-door container (width 2340 mm×height 2585 mm×length 12055 mm). Correspondingly, after the folded pre-assembled photovoltaic system is placed on a pallet 5, a depth dimension L may be 2400±20 mm, a width dimension W may be 1130±20 mm, and a height dimension H may be 2510±20 mm. A matching relationship between dimensions of the container and dimensions of the folded pre-assembled photovoltaic system needs to be in one-to-one correspondence. The width, the depth, and the height of the folded pre-assembled photovoltaic system correspond to the width, the depth, and the length of the container.

As shown in FIG. 24, 10 pre-assembled photovoltaic systems 100 may be placed inside a 40-foot high-door container. Five rows of pre-assembled photovoltaic systems 100 may be placed in a direction of a length L1 of the container, and two columns of pre-assembled photovoltaic systems 100 may be placed in a direction of a width W1 of the container. Because a length dimension LI of the container is 12055 mm, after a proper deployment gap is reserved, a sum of depths of the five rows of pre-assembled photovoltaic systems 100 with a depth dimension L of 2400±20 mm basically corresponds to the length dimension of the container. Because the width dimension W1 of the container is 2340 mm, after a proper deployment gap is reserved, a sum of widths of the two columns of pre-assembled photovoltaic systems 100 with a width W of 1130±20 mm basically corresponds to the width dimension of the container.

In conclusion, the pre-assembled photovoltaic system according to this embodiment of the present disclosure may include at least the following advantages:

In this embodiment of the present disclosure, the photovoltaic module may be mounted on the foldable support before the pre-assembled photovoltaic system leaves a factory. Then, the overall pre-assembled photovoltaic system is folded by folding the foldable support, so that an overall volume of the pre-assembled photovoltaic system is relatively small, thereby facilitating transportation of the pre-assembled photovoltaic system. After the pre-assembled photovoltaic system is transported to amounting site, the pre-assembled photovoltaic system can be unfolded only by mounting the foldable support to the mounting platform on the mounting site. The limiting device may be configured to control unfolding angles between the foldable supports to improve structural stability of the pre-assembled photovoltaic system. In this way, the pre-assembled photovoltaic system according to this embodiment of the present disclosure facilitates transporting, can greatly shorten on-site construction time, simplify manual operation procedures, and greatly improve on-site mounting efficiency.

In the description of this specification, the description of the reference terms such as “an embodiment”, “some embodiments”, “exemplary embodiments”, “example”, “specific example”, or “some examples” means that the specific features, structures, materials or characteristics described with reference to the embodiment or example are included in at least one embodiment or example of the present invention. In this specification, exemplary descriptions of the foregoing terms do not necessarily refer to the same embodiment or example. In addition, the described specific features, structures, materials, or characteristics may be combined in a proper manner in any one or more of the embodiments or examples.

Although the embodiments of the present disclosure have been shown and described, those of ordinary skill in the art may understand that: Various changes, modifications, replacements and variations may be made to the embodiments without departing from the principles and spirit of the present disclosure, and the scope of the present disclosure is as defined by the appended claims and their equivalents.

1. A pre-assembled photovoltaic system comprising:
a foldable support;
a plurality of photovoltaic modules connected to the foldable support; and
a limiting device connected to the foldable support, wherein the limiting device is configured to control one or more unfolding angles of the foldable support.

2. The pre-assembled photovoltaic system of claim 1, wherein the foldable support comprises a plurality of limit plates arranged on the foldable support along an unfolding direction of the foldable support, and,
wherein, when the foldable support is unfolded to a preset angle, adjacent limit plates of the plurality of limit plates are configured to abut against each other to prevent the foldable support from further unfolding.

3. The pre-assembled photovoltaic system of claim 1, wherein the foldable support comprises:
at least one pair of cross beams arranged along an unfolding direction of the foldable support; and
a support unit hinged between a pair of cross beams of the at least one pair of cross beams.

4. The pre-assembled photovoltaic system of claim 3, wherein the foldable support further comprises a pair of stop plates disposed at a bottom of the pair of cross beams, and
wherein, when the foldable support is unfolded, a stop plate of the pair of stop plates is configured to prevent a corresponding cross beam of the pair of cross beams from flipping, and
wherein, when the foldable support is in a closed position, the pair of stop plates is configured to abut against each other.

5. The pre-assembled photovoltaic system of claim 4, wherein the stop plate comprises:
a bottom plate that is connected to a bottom of the corresponding cross beam and extends in a first direction; and
two warping plates that are disposed at two ends of the bottom plate and extend in a second direction,
wherein an included angle between the first direction and the second direction is in a range from 0° to 90°.

6. The pre-assembled photovoltaic system of claim 3, wherein the support unit comprises:
a first support element, wherein a first end of the first support element is hinged to a first cross beam of the pair of cross beams; and
a second support element, wherein a first end of the second support element is hinged to a second cross beam of the pair of cross beams and a second end of the second support element is hinged to a second end of the first support element,
wherein the plurality of photovoltaic modules comprises:
at least one first photovoltaic module connected to the first support element, and
at least one second photovoltaic module connected to the second support element.

7. The pre-assembled photovoltaic system of claim 6, wherein the support unit further comprises:
a first hinge connected between the first support element and the second support element; and
two second hinges, wherein a first one of the two second hinges is connected between the first support element and the first cross beam, and a second one of the two second hinge pieces is connected between the second support element and the second cross beam.

8. The pre-assembled photovoltaic system of claim 7, wherein the first hinge comprises:
a first rotating shaft; and
a first part and a second part that are sleeved over the first rotating shaft, wherein the first part is connected to the first support element, and the second part is connected to the second support element; and
a pair of limit plates disposed on the first part and the second part respectively,
wherein, when the foldable support is in a closed position, adjacent limit plates of adjacent support units abut against each other, and
wherein, when the foldable support is unfolded to a preset angle, the pair of limit plates is configured to abut against each other to prevent the foldable support from further unfolding.

9. The pre-assembled photovoltaic system of claim 8, wherein a limit plate of the pair of limit plates comprises an extension plate and a bent plate,
wherein a first end of the extension plate is connected to a corresponding one of the first part and the second part, and the bent plate is disposed at a second end of the extension plate, and
wherein, in the first hinge, bent plates on the first part and on the second part are disposed opposite to each other.

10. The pre-assembled photovoltaic system of claim 7, wherein a second hinge of the two second hinges comprises:
a second rotating shaft; and
a third part and a fourth part that are sleeved over the second rotating shaft, wherein the third part is connected to a corresponding one of the first support element and the second support element, and the fourth part is connected to a corresponding cross beam of the pair of cross beams, and
wherein the second hinge further comprises at least one of:
an anti-tip plate arranged on the third part extending outward, wherein, when the foldable support is in a closed position, the anti-tip plate is located among the first support element, the second support element, and the corresponding cross beam, or
a limit part in at least one of the third part or the fourth part, wherein, when the foldable support is in a closed position, the third part and the fourth part abut against each other through the limit part.

11. The pre-assembled photovoltaic system of claim 6, wherein the first support element and the second support element comprise at least two longitudinal beams and at least two transverse purlins respectively,
wherein the at least two longitudinal beams and the at least two transverse purlins are connected perpendicularly or crosswise to form grid frames, and
wherein the at least one first photovoltaic module and the at least one second photovoltaic module are fixed to the grid frames.

12. The pre-assembled photovoltaic system of claim 11, wherein the first support element comprises a first longitudinal beam, and the second support element comprises a second longitudinal beam, and
wherein one of the first longitudinal beam and the second longitudinal beam has an open end, and the open end faces a side away from a corresponding photovoltaic module, and wherein a width of the one of the first longitudinal beam and the second longitudinal beam having the open end is greater than a width of the other one of the first longitudinal beam and the second longitudinal beam.

13. The pre-assembled photovoltaic system of claim 11, wherein a position of a first longitudinal beam of the first support element is misaligned with a position of a second longitudinal beam of the second support element.

14. The pre-assembled photovoltaic system of claim 11, wherein the limiting device is connected to a longitudinal beam of the at least two longitudinal beams, and
wherein a connection position between the limiting device and the longitudinal beam is a target position, a distance between the target position and a corresponding cross beam is a target distance, and a ratio between the target distance and a total length of the longitudinal beam is greater or equal to 0 and less than or equal to ⅔.

15. The pre-assembled photovoltaic system of claim 6, wherein the limiting device is disposed between the first support element and the second support element in the support unit, and the limiting device is connected to each of the first support element and the second support element, and
wherein, when the foldable support in an unfolded position, an included angle between the first support element and the limiting device in a range from 5° to 30°.

16. The pre-assembled photovoltaic system of claim 3, wherein a cross beam of the at least one pair of cross beams is connected to a mounting platform by at least one of:
the cross beam being mounted on the mounting platform through a fastener,
the cross beam being connected to a pre-buried piece disposed in the mounting platform through a fastener, or
a hoop of the pre-assembled photovoltaic system bypassing the cross beam and being connected to the mounting platform through a fastener.

17. The pre-assembled photovoltaic system of claim 3, further comprising clump weights disposed at two ends of a cross beam of the at least one pair of cross beams, the cross beam is connected to the clump weights, and the clump weights are connected to a mounting platform,
wherein the cross beam and the clump weights are connected by at least one of:
the cross beam being directly mounted on the clump weights through fasteners,
the cross beam being connected to pre-buried pieces disposed in the clump weights through fasteners, or
a hoop of the pre-assembled photovoltaic system bypassing the cross beam and being connected to the clump weights through fasteners.

18. The pre-assembled photovoltaic system of claim 3, wherein the pre-assembled photovoltaic system further comprises clump weights located at two ends of the pre-assembled photovoltaic system along the unfolding direction of the foldable support, pre-assembled photovoltaic system, and
wherein a clump weight at an end of the pre-assembled photovoltaic system comprises a limit slot configured to limit a corresponding cross beam of the at least one pair of cross beams.

19. The pre-assembled photovoltaic system of claim 1, wherein the limiting device comprises at least one of a steel wire rope, a rigid pull rod, a telescopic rod, or a foldable rod.

20. The pre-assembled photovoltaic system of claim 1, wherein, when the foldable support is in a closed position, a size of the pre-assembled photovoltaic system is adapted to a container.
